(19) United States
(12) Patent Application Publication
(10) Pub. No.: US 2025/0001948 A1
(43) Pub. Date: Jan. 2, 2025

(54) VEHICLE RAIL COAT HOOK WITH ADJUSTABLE HOOK POSITION

(71) Applicant: DAEHAN SOLUTION CO., LTD, Incheon (KR)

(72) Inventors: Choong Ho KWON, SEOUL (KR); Ho-Young JEOUNG, Incheon (KR)

(73) Assignee: DAEHAN SOLUTION CO., LTD, Incheon (KR)

(21) Appl. No.: 18/751,891

(22) Filed: Jun. 24, 2024

(30) Foreign Application Priority Data
Jun. 28, 2023 (KR) 10-2023-0083361

(51) Int. Cl. B60R 7/10

(52) U.S. Cl. CPC B60R 7/10

(57) ABSTRACT

According to the present invention, a hook body manufactured for hanging a coat, hanger, or the like is formed to move along a rail, a position of the hook body is adjusted to a position at which it is convenient to use the hook body when the coat, hanger, or the like is hung thereon, and thus an assist handle can be conveniently used without wrinkling or folding the coat or clothes. In particular, according to the present invention, a rail which guides a hook body is formed on at least one edge of both edges of a headliner to be long in a longitudinal direction, and thus a position of the hook body can be conveniently adjusted and the vehicle rail coat hook can be safely used without coming in contact with a passenger or other parts when a coat, hanger, or the like is hung on the hook body. In addition, according to the present invention, two to four hook bodies are provided on a long rail as described above, and thus several articles of clothing, coats, or the like can be hung and stored on the hook bodies at once.

### CROSS-REFERENCE TO RELATED APPLICATION

This application claims priority to and the benefit of Korean Patent Application No. 10-2023-0083361, filed on Jun. 28, 2023, the disclosure of which is incorporated herein by reference in its entirety.

### BACKGROUND

### 1. Field of the Invention

The present invention relates to a vehicle rail coat hook with adjustable hook position, and more specifically, to a vehicle rail coat hook of which a hook body for hanging clothes or hangers moves along a rail so that a user adjusts a position of the hook body to a position desired by the user and uses the hook body to conveniently hang various type of coats or other things such as towels on the vehicle rail coat hook to improve convenience.

### 2. Discussion of Related Art

In general, as illustrated in FIGS. 1 and 2, a coat hook H is formed on a headliner L to hang clothes, hangers, or the like on an assist handle A. In this case, the coat hook H may be manufactured as a protruding type and may not be visible in a vehicle interior when not in use, enhancing aesthetics and a sense of beauty of the vehicle interior.

Technologies about coat hooks installed on such existing headliners are disclosed in the following Patent Documents 1 to 3.

### (Patent Document 1) Korean Patent Laid-Open No. 10-2023-0060350

This relates to an assembly structure of a vehicle coat hook and may provide an assembly structure of a vehicle coat hook including: a pillar trim through which a long hole is formed to pass, a coat hook which has an installation part formed in a shape corresponding to the long hole to pass through the long hole and a hook part integrally formed with the installation part and provided outside the pillar trim and is rotation-assembled with the pillar trim, and a support unit which is provided inside the pillar trim and assembled when rotated at a predetermined angle in a first direction in which the coat hook is rotation-assembled and which restricts movement of the installation part when rotated in a second direction opposite to the first direction.

### (Patent Document 2) Korean Patent Laid-Open No. 10-2020-0071157

A coat hook is provided to be stored in a handle body when not in use, and can be used after being withdrawn therefrom only when used, and thus the coat hook can be used by passengers using an auxiliary handle and is not inconvenient to the passengers, and since the coat hook can be manufactured to be viewed as being integrated with a handle, the sense of heterogeneity can be reduced. In particular, since the coat hook is formed to be easily withdrawn from the handle body when a slider which supports the coat hook is pressed, anyone can easily withdraw the slide and quickly and conveniently use the slide as a hanger when hanging a coat. In addition, since the coat hook is formed in a one touch type to be stored in or withdrawn from a storage space as described above, a structure is simple, and the coat hook can be withdrawn and conveniently used through a simple manipulation of pressing the slide.

### (Patent Document 3) Korean Utility Model Registration No. 20-0443316

This relates to a rotation type vehicle coat hook including: a base plate having a first base part in which both surfaces of one side of a conventional assist handle, of which both end portions are fixed to a headlining member located above a vehicle door and which functions as an auxiliary handle, are surrounded by a pair of protruding guide parts and which is close to an arc-type base surface, is fixed by a shaft, and is screw-coupled to the headlining member through a through hole formed in a central portion of a bottom surface of a flat type base surface and a second base part which is formed close to the first base part, on which a pair of protruding parts are formed, and which includes a base surface on which a straight protruding part is formed on the guide part at one side and which is formed in an inclined arc shape; and a hook unit having a coupling part which is close to the base surface of the second base part, is surrounded by the guide part, and is fixed by a shaft and a hook part which extends from the coupling part to be bent in an arc shape, wherein a groove corresponding to the straight protruding part is formed in one surface of the coupling part, and a recess part is formed in the other surface for a compression spring to be installed in the recess part.

### RELATED ART

### Patent Document

(Patent Document 1) Korean Patent Laid-Open No. 10-2023-0060350 (Publication date: May 4, 2023)

(Patent Document 2) Korean Patent Laid-Open No. 10-2020-0071157 (Publication date: Jun. 19, 2020)

(Patent Document 3) Korean Utility Model Registration No. 20-0443316 (Registration date: Jan. 28, 2009)

### SUMMARY OF THE INVENTION

However, such an existing coat hook has the following problems.
(1) Since a coat hook is integrally manufactured with an assist handle or mounted near the assist handle and used, the location of the coat hook cannot be adjusted according to the size of a coat or a type of clothes to be hung.
(2) That is, since the coat hook should be held by a passenger sitting on a seat, the coat hook is mounted on a headliner to be located above the seat, and thus the coat or clothes can be in contact with the seat when the size or length of the coat or clothes is large or long.
(3) The coat or clothes in contact with the seat, as described above, can be folded and wrinkled when the coat or clothes are hung and stored thereon, causing inconvenience such as re-cleaning and the like.
(4) In addition, when the clothes or hangers are hung on the coat hook in a state in which several people are sitting on a seat, not only is it uncomfortable when the passengers use the assist handle, but in a severe case, the passengers can lose their balance because the passengers cannot hold the assist handle with their hand.

The present invention is directed to providing a vehicle rail coat hook with adjustable hook position, of which a hook body manufactured for hanging a coat, hanger, or the like is formed to move along a rail, and a position of the hook body is adjusted to a position at which it is convenient to use the hook body when the coat, hanger, or the like is hung, so that an assist handle can be conveniently used without wrinkling or folding the coat or clothes.

In particular, the present invention is also directed to providing a vehicle rail coat hook with adjustable hook position, of which a position of the hook body can be simply and conveniently adjusted and safely used without coming in contact with a passenger or other parts when a coat, hanger, or the like is hung on the hook body by forming a rail for guiding a hook body to be long on at least one edge of both edges of a headliner in a longitudinal direction.

In addition, the present invention is also directed to providing a vehicle rail coat hook with adjustable hook position, in which two to four hook bodies are provided on a long rail as described above so that several articles of clothing, coats, or the like can be hung and stored on the hook bodies at once.

According to an aspect of the present invention, there is provided a vehicle rail coat hook with adjustable hook position, which is mounted in a slot (S) formed in a headliner (L) mounted in a vehicle interior to face a roof panel, the vehicle rail coat hook including a rail body (100) mounted in the slot (S) and a hook body (200) which is mounted in the rail body (100) and slid in a longitudinal direction to hang clothes or a hanger, wherein the rail body (100) is formed to have a hollow inner portion and installed on the headliner (L), wherein a long hole (110) is formed in a surface, which is exposed to the vehicle interior, of the rail body (100) to be long in the longitudinal direction, a guide (120) of which a portion facing the long hole (110) is cut to pass through the guide (120) is formed in the hollow portion, a flange (130) is formed on an edge of the surface, in which the long hole (110) is formed, to be fixedly caught in and not separated from the slot (S), and the hook body (200) has one side on which a guide protrusion (210) which is fitted into, not withdrawn from, and slid in the guide (120) is formed and the other side on which the clothes or hanger is hung is formed to protrude outward from the rail body (100) through the long hole (110).

In particular, the slot (S) may be formed as at least one slot in at least one edge of both edges of the headliner (L) to be long in a traveling direction of a vehicle.

In addition, the hook body (200) may be provided as two to four hook bodies.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a bottom view illustrating a headliner for showing a coat hook formed on a conventional assist handle;

FIG. 2 is a perspective view illustrating a state in which a hanger is hung on the coat hook formed on the conventional assist handle;

FIG. 3 is a perspective view illustrating a state in which a vehicle rail coat hook with adjustable hook position according to the present invention is mounted on a headliner;

A set of FIG. 4A, FIG. 4B is a view showing an entire shape of the vehicle rail coat hook with adjustable hook position, wherein FIG. 4A shows a front perspective view thereof, and FIG. 4B shows a rear perspective view thereof;

FIG. 5 is an exploded cross-sectional perspective view of a hook body along a portion of a rail body to show an entire structure of the vehicle rail coat hook with adjustable hook position according to the present invention; and

FIG. 6 is a cross-sectional view illustrating the entire structure of the vehicle rail coat hook with adjustable hook position in a longitudinal direction.

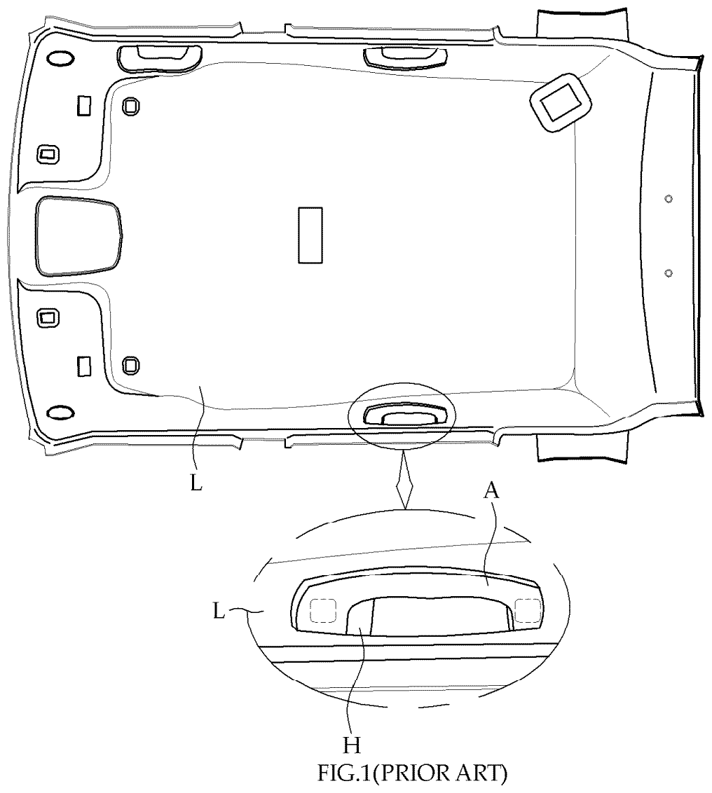

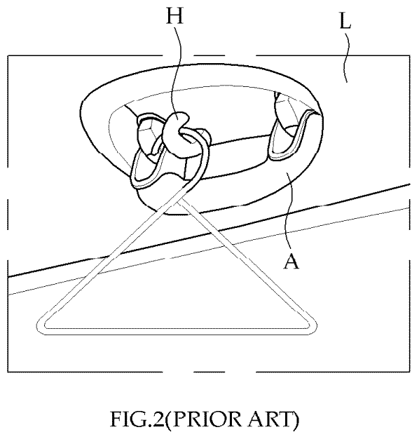

### DETAILED DESCRIPTION OF EXEMPLARY EMBODIMENTS

Hereinafter, exemplary embodiments of the present invention will be described in more detail with reference to the accompanying drawings. Moreover, terms and words used in the present specification and claims should not be interpreted as being limited to commonly used meanings or meanings in dictionaries and should be interpreted as having meanings and concepts which are consistent with the technological scope of the invention based on the principle that the inventors have appropriately defined concepts of terms in order to describe the invention in the best way.

Therefore, since the embodiments described in this specification and components illustrated in the drawings are only exemplary embodiments and do not represent the overall technological scope of the invention, it should be understood that there may be various equivalents or modifications that can be substituted in the exemplary embodiments at the time of filing of this application.

### Structure of Vehicle Coat Rail Hook

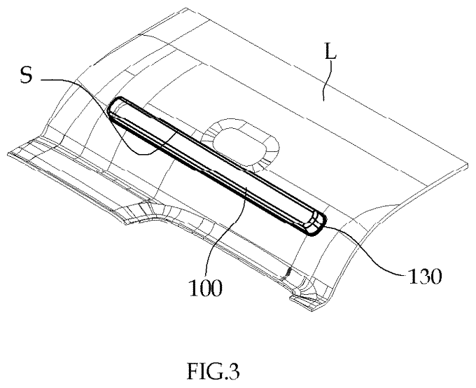

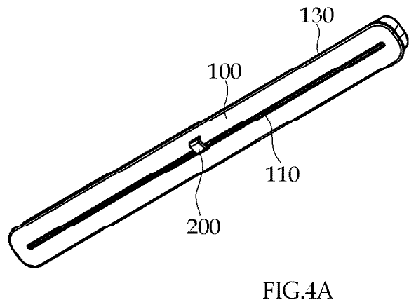

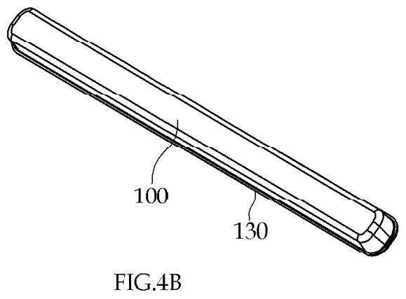

As illustrated in FIGS. 3 to 6, a vehicle rail coat hook with adjustable hook position includes a rail body 100 and a hook body 200.

In particular, as the hook body 200 is installed to be fitted into the rail body 100 to move in a longitudinal direction, a position of the hook body 200 may be adjusted such that a coat or clothes do not overlap or are not in contact with a seat or the like in consideration of a length, an area, and the like of the coat or hanger to be hung on the hook body, and the hook body 200 may be conveniently used.

In addition, since two to four hook bodies 200 are provided on one rail body 100, several long articles of clothing or coats may be hung and stored simultaneously on the rail body 100, and other things to be hung may also be hung and stored thereon.

Meanwhile, as at least one rail body 100 is formed at one edge of both edges of a headliner L to be long in a traveling direction of a vehicle, a position of the hook body 200 may be adjusted to a desired position, or several hook bodies 200 may be provided for several articles of clothing or other things to be hung and stored thereon.

Such a structure will be described in more detail below with reference to the accompanying drawings.

### A. Rail Body

As illustrated in FIGS. 3 to 6, the rail body 100 is formed long and mounted on the headliner L. In this case, a slot S is formed long in the headliner L for the rail body 100 to be mounted on the headliner L.

In the exemplary embodiment of the present invention, the slot S may be formed to correspond to a length and a shape of the rail body 100 as illustrated in FIG. 3, and at least one slot S may be formed in one edge of both edges of the headliner L to be long in the traveling direction of the vehicle. This is to allow the hook body 200, which is movable in the longitudinal direction and will be described below, to move by as much as a length of the rail body 100 so that the coat or clothes are hung at a desired position.

Meanwhile, the rail body 100 is formed to have a hollow inner portion, and as illustrated in FIGS. 3 to 6, the rail body 100 is provided with a long hole 110, a guide 120, and a flange 130.

### 1. Long Hole

As illustrated in FIGS. 4 to 6, the long hole 110 is formed in a surface, which is exposed to a vehicle interior, of the rail body 100 in the longitudinal direction when the rail body 100 is mounted in the slot S. In this case, the long hole 110 serves to guide the hook body 200 protruding outward from the rail body 100 to move to a desired position.

### 2. Guide

As illustrated in FIGS. 4 to 6, the guide 120 is formed in the rail body 100 to be long in the longitudinal direction and guides a guide protrusion 210 of the hook body 200, which will be described below, such that it does not separate. Accordingly, a portion of a surface of the guide 120 facing the long hole 110 is formed to be open so that a cross section in a width direction has a “C” shape. This is for the guide protrusion 210 to be fitted into and slidably guided by the guide 120, and for the guide protrusion 210 to be prevented from being separated or escaping from the guide 120.

### 3. Flange

As illustrated in FIGS. 3 to 6, the flange 130 is formed on an edge of the surface in which the long hole 110 is formed. In this case, when the rail body 100 is inserted into and assembled with the slot S, the flange 130 is caught on an edge of the slot S to achieve a finishing effect, and the rail body 100 is integrally and fixedly attached to the headliner L using the flange 130.

### B. Hook Body

As illustrated in FIGS. 4 to 6, the hook body 200 is formed such that one side is fitted into the rail body 100 through the long hole 110 and guided to move to a desired position.

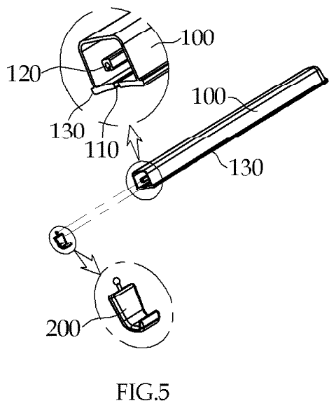

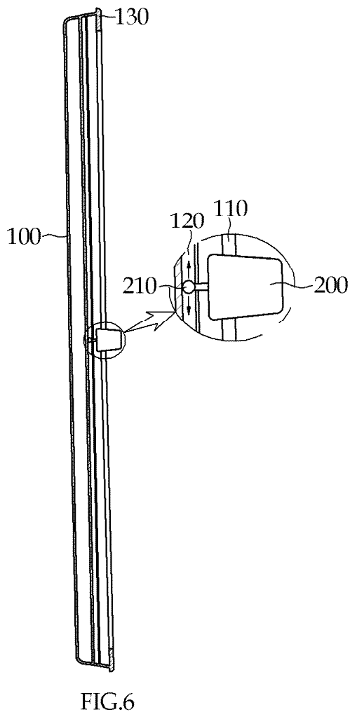

In this case, as illustrated in FIGS. 5 and 6, as the guide protrusion 210 is formed on a portion of the hook body 200 inserted into the long hole 110, the guide protrusion 210 is fitted into and not withdrawn from the guide 120, and the hook body 200 is formed to protrude outward through a cut portion of the guide 120, the guide protrusion 210 is guided by the guide 120, the hook body 200 is not interfered with by the long hole 110, and thus the position of the hook body 200 may be moved to a desired position in the longitudinal direction of the rail body 100.

In the exemplary embodiment of the present invention, as two to four hook bodies 200 are provided on the rail body 100, distances between two adjacent hook bodies 200 can be adjusted to prevent contamination or contact therebetween and can also be conveniently used.

As described above, the present invention is provided so that a position of the hook body is adjusted along the rail body in the longitudinal direction to minimize contact between the coat or clothes and the seat and also allow the coat hook to be easily and conveniently used.

A vehicle rail coat hook with adjustable hook position according to the present invention has the following effects.
(1) Since a hook body can be used while a position of the hook body moves in a longitudinal direction of a rail guide, a coat, hanger, or the like does not come in contact with other parts or is not folded, and the coat or hanger can also be hung.
(2) In addition, even when there is a passenger on a back seat, as a position of a coat hook is adjusted, it is convenient because the passenger can still comfortably use an assist handle while the coat, hanger, or the like is hung.
(3) Meanwhile, as the rail guide is provided as at least one rail guide on at least one edge of both edges of a headliner to be long in a traveling direction of a vehicle, the hook body can be conveniently and safely used by properly adjusting the hook body to correspond to a type, a length, and a width of a thing to be hung and stored.
(4) In addition, as two to four hook bodies are mounted on a rail guide and used, even when several articles of clothing, coats, or hangers are hung and used, the clothing, coats, or hangers can minimally overlap and can be conveniently stored and used.

What is claimed is:

1. A vehicle rail coat hook with adjustable hook position, which is mounted in a slot (S) formed in a headliner (L) mounted in a vehicle interior to face a roof panel, the vehicle rail coat hook comprising:
a rail body (100) mounted in the slot (S); and
a hook body (200) which is mounted in the rail body (100) and slid in a longitudinal direction to hang clothes or a hanger,
wherein the rail body (100) is formed to have a hollow inner portion and installed on the headliner (L), wherein a long hole (110) is formed in a surface, which is exposed to the vehicle interior, of the rail body (100) to be long in the longitudinal direction, a guide (120) of which a portion facing the long hole (110) is cut to pass through the guide (120) is formed in the hollow portion, a flange (130) is formed on an edge of the surface, in which the long hole (110) is formed, to be fixedly caught in and not separated from the slot (S), and
the hook body (200) has one side on which a guide protrusion (210) which is fitted into, not withdrawn from, and slid in the guide (120) is formed and the other side on which the clothes or hanger is hung is formed to protrude outward from the rail body (100) through the long hole (110).

2. The vehicle rail coat hook of claim 1, wherein the slot (S) is formed as at least one slot in at least one edge of both edges of the headliner (L) to be long in a traveling direction of a vehicle.

3. The vehicle rail coat hook of claim 1 or 2, wherein the hook body (200) is provided as two to four hook bodies.
